(19) United States
(12) Patent Application Publication
(10) Pub. No.: US 2001/0007815 A1
(43) Pub. Date: Jul. 12, 2001

(54) Method and system for establishing a short-range radio link

(75) Inventor: Lars Philipsson, Lund (SE)

Correspondence Address: Gerald T. Welch, Jenkens & Gilchrist, P.C., 3200 Fountain Place, 1445 Ross Avenue, Dallas, TX, 75202-2799, US

(73) Assignee: TELEFONAKTIEBOLAGET L M ERICSSON (publ)

(21) Appl. No.: 09/738,226

(22) Filed: Dec. 15, 2000

(30) Foreign Application Priority Data
Dec. 17, 1999 (SE) 9904683-1

(51) Int. Cl. H04B 5/00

(52) U.S. Cl. 455/41; 455/558; 340/10.1

(57) ABSTRACT

A method and system for establishing a first short-range radio link, operating within a first link range (13), between a stationary unit (12) and a mobile communication device (10, A) in a wireless network environment, wherein the stationary unit (12) transmits an interrogation signal to said mobile communication device (10, A) via a short-range communication link operating within a second link range (14) essentially smaller than said first link range (13). The mobile communication device (10, A) receives the interrogation signal from the stationary unit (12), and generates and transmitting a respond signal, including a unique identification number of the mobile communication device (10, A), to said interrogation signal. The stationary unit (12) receives said respond signal, and authenticate the identification number. Finally, the stationary unit (12) and said mobile communication device (10, A) establish a connection via said first shorn-range radio link.

### FIELD OF THE INVENTION

The present invention relates to a method and system for establishing a radio link between a stationary unit and a mobile communication device, and more particularly to a method and system for establishing a short-range radio link between a stationary unit and a mobile communication device in a wireless network environment comprising a plurality of mobile communication devices.

### DESCRIPTION OF THE PRIOR ART

There are some well-known methods and systems for establishing connections for wireless communication between stationary units and mobile communication devices. Bluetooth is a technology based on a short-range radio link utilising a microchip facilitating protected ad hoc connections for stationary and mobile communication units in wireless environments. Bluetooth technology allows for the replacement of cables connecting a device to another with a universal short-range radio link. For example, this Bluetooth technology can be built into cellular phones, laptops, printers, PDAs, fax machines, pay terminals, and several other digital devices. Further, the Bluetooth technology is designed to operate in a noise radio frequency environment, and uses a fast acknowledgement and frequency hopping scheme to make the link robust. Bluetooth radio modules avoid interference from other signal by hopping to a new frequency after transmitting or receiving a packet.

However, there is a problem associated with the procedure of establishing a short-range radio channel between one stationary unit and a particular mobile unit from a plurality of mobile units, located within the range of the short-range radio link. In this case, confusion may occur regarding with which one of the mobile units the stationary unit should establish the connection.

In a particular wireless communication application, a wireless electronic pay terminal is provided with a short-range radio frequency unit and a microchip for communication with a stationary point of sale terminal. The point of sale terminal comprises a corresponding short-range radio frequency unit and a microchip. Assume a situation where several customers provided with a wireless electronic pay terminal, as described above, queue at the point of sale for paying the wares at the electronic point of sale terminal. In this case, a plurality of customers and their pay terminals will be located within the range of the short-range radio link. Thus, the point of sale terminal has difficulties in determining which one of the queuing customers (the first one) being the next in turn and an object for establishing a communication in order to debit the customer and exchange other data between the point of sale terminal and the particular pay terminal.

### SUMMARY OF THE INVENTION

Therefore, it is an object of the present invention to provide a method and system for establishing a short-range radio link between a stationary unit and a particular mobile communication device for transactions in a wireless network environment including a plurality of mobile communication devices within the range of the short-range radio link.

This is accomplished by a method and system according to the present invention, wherein the particular mobile communication device, which is subject to the current communication, is identified by transmitting a signal including a unique identification number of the mobile communication device to the stationary unit through another short-range communication link than the short-range radio link, which is used for the current transaction and data exchange. The short-range communication link used for identification operates within a link range essentially smaller than the link range of the radio link used for the transaction.

Another object of the invention is to provide a mobile communication device for use in a wireless communication network, comprising a an ID transponder for receiving an interrogation signal from a stationary unit and generating a respond signal to said interrogation signal, including a unique identification number of the mobile communication device for authentication in a stationary unit, and for establishing a connection with the stationary unit via a short-range radio link.

Still another object of the invention is to provide a stationary unit for use in a wireless communication network, wherein the stationary unit comprises a short-range radio frequency unit for communication with a mobile communication device via a short-range radio link, and a short-range communication unit for communication with the mobile communication device via another short-range communication link, operating within a second link range essentially smaller than the first link range. Through the short-range communication link, the stationary unit transmits an interrogation signal to the mobile communication device and receives a respond signal, including a unique identification number, from the mobile communication device, and authenticates the identification number in order to establish a connection with the mobile communication device via the short-range radio link.

### BRIEF DESCRIPTION OF THE DRAWINGS

In order to explain the invention in more detail and the advantages and features of the invention, a preferred embodiment will be described in detail below, reference being made to the accompanying drawings in which

FIG. 1A is a schematical view of a wireless communication system according to the invention,

FIG. 1B is a schematical view of a plurality of wireless communication systems according to the invention,

FIG. 2 is a block diagram of a mobile communication device according to the invention including an ID transponder,

FIG. 3 is a schematic diagram of a first embodiment of the ID transponder in FIG. 2,

FIG. 4A is a block diagram of a first embodiment of a stationary unit according to the invention, and

FIG. 5 is a flow chart of the method of establishing a short-range radio link according to the invention.

### DETAILED DESCRIPTION OF THE INVENTION

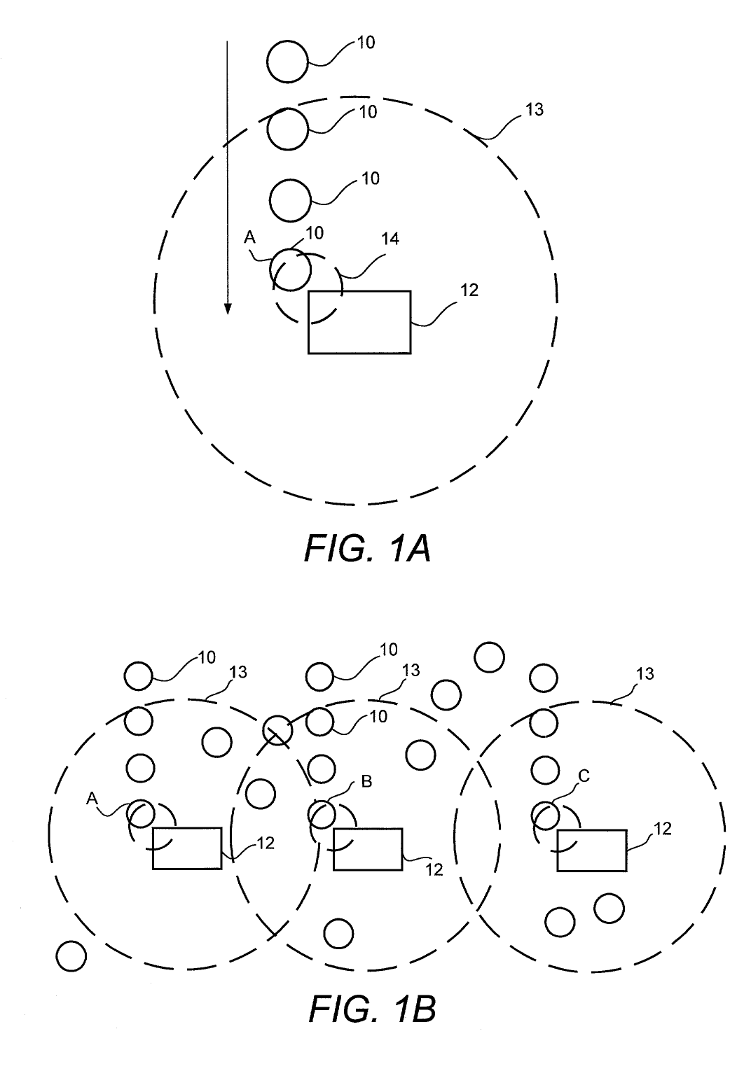

FIG. 1A shows an illustrative view of a wireless communication system according to the invention. For the purpose of illustration the wireless communication system according to the invention is described in connection with a particular wireless communication application, wherein a first short-range radio link is to be established between a wireless electronic pay terminal 10 and a stationary point of sale terminal 12 for communication of transaction data during a payment procedure. In this embodiment of the invention a Bluetooth link with a range 13 of about 10 m is used for the first short-range radio link.

An environment, such as in a supermarket, including several customers provided with wireless electronic pay terminals 10 queuing at a plurality of point of sale terminals 12 for paying the wares is shown in FIG. 1B. In this case, a number of pay terminals 10 will be located within the range of the first short-range radio link. Thus, an identification or authentication of which one of the queuing customers (the first one) being the next in turn has to be performed by each of the sale terminals 12. Thus, the particular pay terminal held by the first customer in the queue which is also the closest one to the point of sale terminal 12 is the next object for establishing a communication with the sale terminal 12. The closest pay terminal 10 is denoted A in FIG. 1A. In FIG. 1B there are two additional “closest” pay terminals B and C, which are located first in their respective queues.

The identification is performed by transmitting a signal including a unique identification number of the pay terminal A to the point of sale terminal through another short-range communication link than the short-range radio link, which is used for the current transaction and data exchange. The short-range communication link used for identification operates within a second link range, illustrated by a small dashed circle 14 in FIGS. 1A and 1B, essentially smaller than the link range of the radio link used for the transaction.

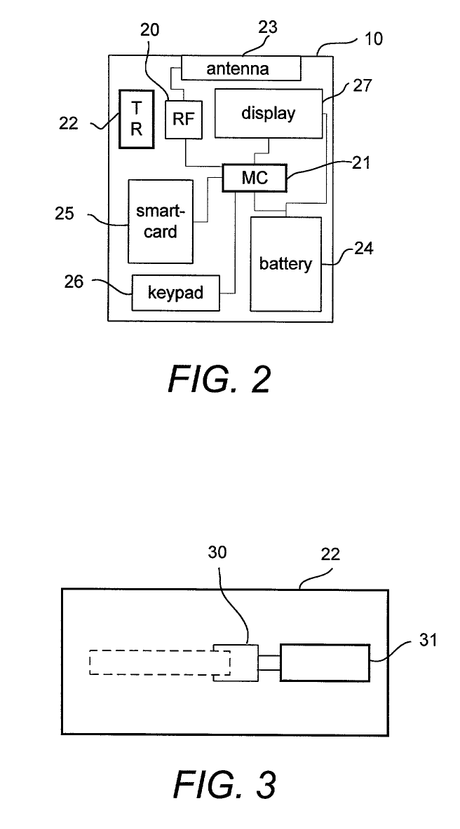

A block diagram of a pay terminal 10 according to the invention is shown in FIG. 2. The pay terminal comprises a short-range radio frequency unit 20 operatively connected to at least one microchip 21, which facilitates ad hoc connection with the point of sale terminal 12 via a short-range radio link operating within the first link range 13. The pay terminal 10 further comprises a passive radio frequency ID transponder 22 for communication with said point of sale terminal 12 via a short-range radio link. This link operates within the second link range 14 which is essentially smaller than the first link range 13. The second link range should be limited to about 50 cm. However, it can still operate properly up to about 1 m. However, the preferred range of the second short-range link is 0-20 cm.

The transponder 22 is adapted for receiving an interrogation signal from the point of sale terminal 12, and generating a respond signal to the interrogation signal. The signal includes a unique identification number, stored in storage means in the transponder 22, of the particular pay terminal 10. Further, the pay terminal and its microchip is adapted for establishing a connection with the point of sale terminal 12 by means of the short-range radio frequency unit 20 and its antenna 23 via the short-range radio link 13.

Power supply for the pay terminal 10 and its components is preferably provided by means of a battery 24. A smartcard 25 including at least one microchip and storage means are attached to the pay terminal and operatively connected to the internal microchip 21. The pay terminal is operated by a keypad 26 and information about transactions etc. appears on a display 27.

The passive radio frequency transponder 22 is shown in further detail in FIG. 3. The transponder comprises an antenna coil 30 connected to a microchip 31 including a user-programmable EEPROM 31 with the unique identification number of the pay terminal 10 and additional circuitry. The transponder is capable of receiving an interrogation signal transmitted from the sale terminal 12 and separating the radio-frequency energy from the received signal. This energy is utilised by the transponder for supplying its operation. Thus, the interrogation signal is analysed and a respond signal including the unique identification number is send to the sale terminal 12.

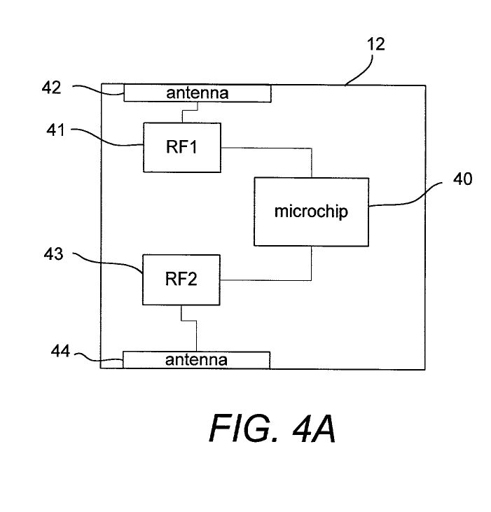

A first embodiment of the electronic point of sale terminal 12 is illustrated as block diagram in FIG. 4A. The point of sale terminal 12 comprises at least one microchip operatively connected to a first short-range radio frequency unit 41 for communication with the pay terminal 10 via a first antenna 42. As described above, this first radio link is used for transaction data. For the identification procedure, a second radio link is used, which operates within the second link range 14, essentially smaller than the first link range 13. Therefore, the sale terminal 12 is provided with a second radio frequency unit 43 and a suitable antenna 44. The sale terminal 12 and its microchip 40 is capable of transmitting an interrogation signal to the pay terminal 10 via the second radio link, and receiving a respond signal including the unique identification number of the pay terminal 10 via the second radio link. Further the microchip is adapted for authenticating the identification number, and then establishing a connection with said pay terminal 2 via the first radio link.

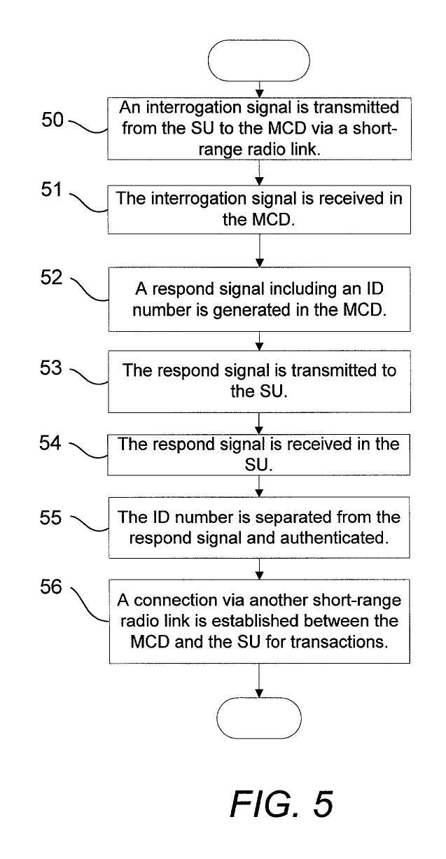

A method according to the present invention for establishing a first short-range radio link, operating within a first link range, between the point of sale terminal 12 and the pay terminal A in the wireless network environment shown in FIGS. 1A and 1B, is illustrated by the flowchart in FIG. 5.

When the point of sale terminal 12 and the particular pay terminal A are within the range of the second short-range communication link, an interrogation signal is transmitted from the point of sale terminal 12 to the pay terminal B via the second short-range communication link in step 50. The transponder 22 in the pay terminal A receives the interrogation signal in step 51. A respond signal, including a unique identification number of the pay terminal A stored in the storage means of the transponder, is generated in the microchip in step 52 and transmitted through the second communication link to the point of sale terminal 12 via its second communication unit 43 or 45 in step 53. The respond signal is received in the point of sale terminal 12 in step 54, and the identification number is separated from the signal and authenticated by the microchip 40 in step 55. If the identification number is authenticated properly, the point of sale terminal finally establishes a connection with the pay terminal A via the first short-range radio link.

Hence, the present invention provides a method and system for establishing a first short-range radio link between a point of sale terminal and a pay terminal for transactions in a wireless network environment including a plurality of pay terminals within the range of the short-range radio link, by utilising another short-range communication link for identification or authentication purpose. However, the present disclosure of the embodiments described is to be considered as exemplification of the invention and it is not intended to limit the invention to the specific embodiments.

In an alternative embodiment of the invention the pay terminal is included in mobile phone or another mobile communication device. Similarly, the point of sale terminal may be another kind of stationary unit.

For example, in an alternative embodiment of the invention the transponder is a TEMIC TK5561A-PP passive ID radio frequency transponder having crypto capability for the information exchange. This transponder operates at the nominal carrier frequency of 125 kHz. Still another example of a suitable transponder is the TIRIS RI-TRP-R9WK or RI-TRP-W9WK provided by Texas Instruments. Other similar transponders can be used within the scope of the invention as disclosed.

The Bluetooth technology, which is used for the first short-range radio link in the above-described embodiments, operates in a range of 10 cm to 100 m in the unlicensed ISM band at 2, 4 GHz. However, other similar wireless network technologies can be used for the first radio link.

1. A mobile communication device for use in a wireless communication network, comprising a short-range radio frequency unit (20) operatively connected to at least one microchip (21), facilitating ad hoc connection with a stationary unit (12) via a first short-range radio link operating within a first link range (13), characterized in that said mobile communication device (10, A) comprises an ID transponder (22) for communication with said stationary unit (12) via a short-range communication link, operating within a second link range (14) essentially smaller than said first link range (13), said transponder having interrogation receive means (30, 31) for receiving an interrogation signal from said stationary unit and responder means (30, 31) for generating a respond signal to said interrogation signal, including a unique identification number of the mobile communication device (10, A), and said mobile communication device comprises link establish means (20, 21, 23) for establishing a connection with the stationary unit (12) via said short-range radio link, after the identification number has been authenticated by said stationary unit (12).

2. A mobile communication device according to claim 1, characterized in that said first radio link is a Bluetooth link.

3. A mobile communication device according to claim 1 or 2, characterized in that said first link range is 10 cm-100 m.

4. A mobile communication device according to claim 3, characterized in that said second link range is less than 50 cm and preferably 0-20 cm.

5. A mobile communication device according to any of the preceding claims characterized in that said transponder (22) is a radio frequency ID transponder and said short-range communication link is a second short-range radio link.

6. A mobile communication device according to any of the preceding claims, characterized in that said transponder (22) is a crypto transponder.

7. A mobile communication device according to any of the preceding claims, characterized in that said mobile communication device (10, A) includes a wireless pay terminal comprising a smartcard (25) including at least one microchip and storage means.

8. A mobile communication device according to claim 7, characterized in that said smartcard (25) is a credit card, a cash-card, and/or a bonus-card.

9. A mobile communication device according to any of the preceding claims, characterized in that said unique identification number is a unique address of the mobile communication device (10, A).

10. A stationary unit for use in a wireless communication network, comprising a first short-range radio frequency unit (41) operatively connected to at least one microchip (40), facilitating ad hoc connection with a mobile communication device (10, A) via a first radio link operating within a first link range (13), characterized in that said stationary unit (12) comprises a short-range communication unit (43) operatively connected to said microchip (40) for communication with said mobile communication device (10, A) via a short-range communication link, operating within a second link range (14) essentially smaller than said first link range (13), transmit means (40, 43, 44; 40, 45, 46) for transmitting an interrogation signal to said mobile communication device (10, A) via said communication link, receive means (40, 43, 44; 40, 45, 46) for receiving a respond signal including a unique identification number from said mobile communication device (10, A) via said communication link, and authenticator means (40) for authenticating the identification number, and link establish means (40, 41, 42) for establishing a connection with said mobile communication device (10, A) via said first radio link.

11. A stationary unit according to claim 10, characterized in that said first radio link is a Bluetooth link.

12. A stationary unit according to claim 10 or 11, characterized in that said first link range is 10 cm-100 m.

13. A stationary unit according to claim 12, characterized in that said second link range is less than 50 cm and preferably 0-20 cm.

14. A stationary unit according to any of the claims 10-13, characterized in that said communication unit is a second short-range radio frequency unit (43) and said short range communication link is a short-range radio link.

15. A stationary unit according to any of the claims 10-14, characterized in that said unique identification number is a unique address of the mobile communication device (10, A).

16. A stationary unit according to any of the claims 10-15, characterized in that said stationary unit includes a point-of-sale terminal.

17. A wireless communication system comprising at least a stationary unit, comprising a first short-range radio frequency unit (41) operatively connected to at least a stationary unit microchip (40), at least a mobile communication device (10, A), comprising a communication device short-range radio frequency unit (20) operatively connected to at least a communication device microchip (21), said microchips (21, 40) facilitating ad hoc connection between said stationary unit (12) and said mobile communication device (10, A) via a first radio link operating within a first link range (13), characterized in that said stationary unit (12) comprises a short-range communication unit (43) operatively connected to said stationary unit microchip (40) for communication with said mobile communication device (10, A) via a short-range communication link, operating within a second link range (14) essentially smaller than said first link range (13), transmit means (40, 43, 44; 40, 45, 46) for transmitting an interrogation signal to said mobile communication device (10, A) via said communication link, receive means (40, 42, 44; 40, 45, 46) for receiving a respond signal including a unique identification number transmitted from said mobile communication device (10, A) via said communication link, and authenticator means (40) for authenticating the identification number, and link establish means (40, 41, 42) for establishing a connection with said mobile communication device (10, A) via said first radio link; said mobile communication device comprises an ID transponder (22) for communication with said stationary unit (12) via said communication link, said transponder having interrogation receive means (30, 31) for receiving an interrogation signal from said stationary unit (12), and responder means (30, 31) for generating said respond signal to said interrogation signal, and said mobile communication device comprises link establish means (20, 21, 23) for establishing a connection with the stationary unit (12) via said first radio link, after the identification number has been authenticated by said stationary unit (12).

18. A wireless communication system according to claim 17, characterized in that said first radio link is a Bluetooth link.

19. A wireless communication system according to claim 17 or 18, characterized in that said first link range is 10 cm-100 m.

20. A wireless communication system according to claim 19, characterized in that said second link range is less than 50 cm and preferably 0-20 cm.

21. A wireless communication system according to any of the claims 17-20, characterized in that said transponder (22) is a radio frequency ID transponder, said communication unit is a second short-range radio frequency unit, and said short-range communication link is a second short-range radio link.

22. A wireless communication system according to any of the claims 17-21, characterized in that said transponder (22) is a crypto transponder.

23. A wireless communication system according to any of the claims 17-22, characterized in that said mobile communication device (10, A) includes a wireless pay terminal comprising a smartcard (25) including at least one microchip and storage means.

24. A wireless communication system according to claim 23, characterized in that said smartcard (25) is a credit card, a cash-card, and/or a bonus-card.

25. A wireless communication system according to any of the claims 17-24, characterized in that said unique identification number is a unique address of the mobile communication device (10, A).

26. A wireless communication system according to any of the claims 17-25, characterized in that said stationary unit (12) includes a point-of-sale terminal.

27. A method of establishing a first short-range radio link, operating within a first link range (13), between a stationary unit (12) and a mobile communication device (10, A) in a wireless network environment, characterized by the steps of
said stationary unit (12) transmitting an interrogation signal to said mobile communication device (10, A) via a short-range communication link operating within a second link range (14) essentially smaller than said first link range (13),
said mobile communication device (10, A) receiving said interrogation signal from said stationary unit (12),
said mobile communication device (10, A) generating and transmitting a respond signal, including a unique identification number of the mobile communication device (10, A), to said interrogation signal,
said stationary unit (12) receiving said respond signal, and authenticating the identification number,
said stationary unit (12) and said mobile communication device (10, A) establishing a connection via said first short-range radio link.

28. A method according to claim 27, characterized in that said first radio link is a Bluetooth link.

29. A method according to claim 27 or 28, characterized in that said first link range is 10 cm-100 m.

30. A method according to claim 29, characterized in that said second link range is less than 50 cm and preferably 0-20 cm.

31. A method according to any of the claims 27-30, characterized in that said unique identification number is a unique address of the mobile communication device (10, A).

32. A method according to any of the claims 27-31, characterized in that said short-range communication link is a second short-range radio link.
